(19) United States
(12) Patent Application Publication
(10) Pub. No.: US 2024/0010133 A1
(43) Pub. Date: Jan. 11, 2024

(54) TOWER ASSEMBLY FOR A ROOF RACK SYSTEM ADAPTED FOR USE WITH A VEHICLE

(71) Applicant: Intelligent Designs 2000 Corp., Aurora, CO (US)

(72) Inventor: Paul Badillo, Aurora, CO (US)

(21) Appl. No.: 18/176,308

(22) Filed: Feb. 28, 2023

Related U.S. Application Data
(63) Continuation-in-part of application No. 29/845,304, filed on Jul. 6, 2022.
Application No. 29/845,304 is a continuation-in-part of application No. 29/845,308, filed on Jul. 6, 2022.
Application No. 29/845,308 is a continuation-in-part of application No. 29/845,311, filed on Jul. 6, 2022.

(51) Int. Cl. B60R 9/045

(52) U.S. Cl. CPC B60R 9/045

(57) ABSTRACT

A tower assembly for a roof rack system adapted for use with a vehicle is provided. The tower assembly is interconnectable to a vehicle frame. A roof rack is pivotably interconnected to the tower assembly such that the roof rack is capable of rotating between a first position of use and a second position of use about an axis through a bracket of the tower assembly. The roof rack system includes a front rack member interconnected to the vehicle proximal to a windshield and A-pillar of the vehicle. The roof rack is in the first position of use when interconnected to the front rack member. The roof rack is rotatable between the first position of use and the second position of use when not interconnected to the front rack member.

### CROSS REFERENCE TO RELATED APPLICATIONS

This application is a Continuation-in-Part application and claims the benefit and priority of U.S. Design patent application Ser. No. 29/845,304 filed on Jul. 6, 2022, U.S. Design patent application Ser. No. 29/845,308 filed on Jul. 6, 2022, and U.S. Design patent application Ser. No. 29/845,311 filed on Jul. 6, 2022, which are each incorporated herein in their entirety by reference.

### FIELD

Embodiments of the present disclosure are generally related to storage and accessory racks for interconnection to motor vehicles. More specifically, one embodiment of the present disclosure comprises a tower assembly operable to be pivotably interconnected to a roof rack. The roof rack is operable to be attached to a front rack member. The front rack member is configured to be positioned adjacent to a forward windshield portion of a vehicle. The roof rack is selectively movable relative to the tower assembly and the front rack member such that the roof rack is capable of moving from a first position of use to a second position of use.

### BACKGROUND

Storage racks are often installed on vehicles to permit carrying additional items that will not fit within the vehicle or are not desirable to carry in the vehicle. Storage racks also often accommodate a variety of accessories including lights, such as fog lights or light bars. It is sometimes necessary to remove the storage rack to make modifications to the vehicle. For example, the storage rack of some vehicles must be removed in order to gain access to various roof elements for removal or replacement. That is, in order to facilitate changing the exterior of a vehicle, the storage rack must be removed. This is often a cumbersome and difficult task and sometimes the aforementioned lights and associated wiring must also be removed. Further complicating this task, storage racks are often heavy, and may be difficult and/or dangerous to remove and replace by a lone individual.

Many known storage racks and rack systems prevent vehicle features from moving or operating as they are intended. For example, storage racks may prevent access to or interfere with operation of doors, liftgates, retractable roofs, sunroofs, windows, and windshields when installed. Some known roof rack systems require holes to be formed in the vehicle to secure elements of the roof rack system to the vehicle. The holes damage the vehicle, are detrimental as they facilitate corrosion, and detract from the appearance of the vehicle when the roof rack system is removed.

### SUMMARY

It is an object of the present disclosure to provide a tower assembly for a roof rack system adapted for use with a vehicle. The tower assembly is operable and adapted to be pivotably interconnected to a roof rack, allowing the roof rack to be capable of moving between a first position of use and a second position of use. The roof rack is also operable and configured to be attached to a front rack member. The front rack member is configured to be positioned adjacent to a forward windshield portion of a vehicle. The roof rack system is operable and configured to cooperate with and enable installation or removal of hard panel roof elements, and/or opening or closing of soft or convertible roof elements. The roof rack system can be secured to the vehicle without forming new or additional holes in the vehicle, and does not interfere with components of the vehicle. Although various embodiments of the present disclosure are particularly well suited for use with the aforementioned roof elements, it should be recognized that the inventions and embodiments provided herein are not limited to such applications. Indeed, inventive concepts of the present disclosure may be provided in combination with and useful in different settings, vehicles, and applications.

In one aspect of the present disclosure is a tower assembly for a roof rack adapted for use with a vehicle. The tower assembly comprises a support tower including a top plate and at least one side plate. The top plate includes a bracket with an aperture to receive an axle for pivotably interconnecting the roof rack to the bracket.

The tower assembly comprises a frame extension coupled to a lower portion of the at least one side plate of the support tower. The frame extension includes an extension side plate and a first extension end plate.

The tower assembly comprises a clamp securable to the frame extension via a first fastener that engages at least one of the first extension end plate and the clamp. Decreasing a distance between the frame extension and the clamp via an engagement of the first fastener selectively secures the tower assembly to a frame of the vehicle.

In some embodiments, the tower assembly further comprises a first stabilizer arm coupled to the support tower and the frame extension. In some embodiments, the support tower further comprises a first tower end plate. The first stabilizer arm is coupled to the first tower end plate and to the first extension end plate of the frame extension.

In some embodiments, the tower assembly further comprises a second stabilizer arm coupled to a second tower end plate of the support tower and a stabilizer flange of a second extension end plate of the frame extension. In some embodiments, the second stabilizer arm is set at an oblique angle relative to the first stabilizer arm.

In some embodiments, at least a portion of the support tower including the bracket is capable of extending through a gap between adjacent exterior components of the vehicle when the tower assembly is secured to the frame. The support tower, the frame extension, and the first stabilizer arm are adjustable relative to one another to reduce interference between the tower assembly and the frame or at least one of the adjacent exterior components of the vehicle.

In some embodiments, the first extension end plate comprises a clamp flange which includes a first through-hole to receive the first fastener. In some embodiments, the clamp is selectively positionable adjacent to an inward portion of the frame and the first extension end plate is selectively positionable adjacent to an outward portion of the frame prior to engagement of the first fastener. The clamp is drawn toward the frame and the frame extension to decrease the distance between the frame extension and the clamp during engagement of the first fastener.

In some embodiments, the at least one side plate of the support tower includes a first side plate that comprises a first upper portion that extends from the top plate of the support tower. The at least one side plate of the support tower optionally includes a second side plate that comprises a second upper portion that extends from the first side plate, the lower portion, and a bottom plate positioned between the lower portion and the second upper portion. The top plate is offset a select distance outward relative to the lower portion via the bottom plate.

In some embodiments, the first side plate is made of metal with a first thickness. Optionally, the second side plate is made of metal with a second thickness that is different than the first thickness. In one embodiment, the first thickness is greater than the second thickness.

In some embodiments, the tower assembly further comprises a second extension end plate opposite to the first extension end plate, and a frame extension stabilizer affixed to the second extension end plate. The frame extension stabilizer is configured to contact a portion of the frame when the tower assembly is secured to the frame. More specifically, the frame extension stabilizer is positioned to contact a portion of the frame that is generally planar. Contact between the frame extension stabilizer and the frame spaces an edge of the extension end plate from the frame and improves stability of the tower assembly with respect to the frame. Moreover, the contact of the frame extension stabilizer with a planar portion of the frame improves alignment of the tower assembly with the vehicle.

In some embodiments, the frame extension is coupled to the support tower via a second fastener. In some embodiments, the tower assembly is selectively securable to the frame of the vehicle without modification of the frame. For example, in one or more embodiments, no holes or apertures are formed, cut, or drilled through the frame or other components of the vehicle when the tower assembly is secured to the vehicle.

In some embodiments, the roof rack is rotatable between a first position of use and a second position of use about a common axis extending through the bracket and the axle when the roof rack is pivotably interconnected to the bracket.

In another aspect of the present disclosure a roof rack system adapted for use with a vehicle is provided. The roof rack system comprises a support tower. The support tower includes a top plate, a bracket extending upwardly from the tower top plate, and a side plate extending downwardly from the top plate.

The tower assembly comprises a frame extension coupled to the support tower. The frame extension includes an extension side plate and a first extension end plate.

The tower assembly comprises a clamp selectively securable to the frame extension via a first fastener. Decreasing a distance between the frame extension and the clamp via an engagement of the first fastener selectively secures the tower assembly to a frame of the vehicle.

The roof rack system comprises a roof rack pivotably interconnectable to the bracket via an axle received within the bracket. The roof rack is rotatable between a first position of use with the roof rack oriented approximately parallel to a roof of the vehicle, and a second position of use with the roof rack oriented at an oblique angle to the roof of the vehicle.

In some embodiments, the roof rack system comprises a front rack member adapted to be secured to the vehicle and positioned adjacent to a windshield of the vehicle. The roof rack is selectively securable to the front rack member. The roof rack is in the first position of use when secured to the front rack member. The roof rack is rotatable between the first position of use and the second position of use when not secured to the front rack member.

In some embodiments, the front rack member includes a lower mounting bracket with a bracket through-hole that is capable of aligning with a trim aperture in a trim piece of the vehicle proximate to the windshield. The lower mounting bracket is selectively securable to the trim piece via a second fastener passed through the bracket through-hole of the lower mounting bracket and into the trim aperture.

In some embodiments, the roof rack system comprises a door clamp member that is couplable to an A-pillar of the vehicle and that includes a clamp through-hole. The front rack member includes a medial mount plate with a plate aperture that is capable of aligning with the clamp through-hole of the door clamp member. The medial mount plate is selectively securable to the door clamp member via a third fastener passed through the clamp through-hole of the door clamp member and engaged to the plate aperture of the medial mount plate.

In another aspect of the present disclosure is a method for interconnecting a roof rack to a vehicle. The method may include, but is not limited to, selectively securing a tower assembly to a frame of the vehicle, the tower assembly comprising a support tower with a bracket, a frame extension, and a frame extension clamp. The method for interconnecting a roof rack to a vehicle may include, but is not limited to, pivotably interconnecting an axle associated with the roof rack to the bracket of the support tower. The roof rack is rotatable between a first position of use and a second position of use about a common axis through the bracket and the axle when the roof rack is pivotably interconnected to the bracket.

In some embodiments, the method for interconnecting a roof rack to a vehicle may include, but is not limited to, selectively securing a front rack member to the vehicle proximate to a windshield of the vehicle. Selectively securing the front rack member may include, but is not limited to, aligning a bracket through-hole of a lower mounting bracket of the front rack member with a trim aperture in a trim piece of the vehicle proximate to the windshield. Selectively securing the front rack member may include, but is not limited to, selectively securing the lower mounting bracket to the trim piece via a first fastener passed through the bracket through-hole of the lower mounting bracket and into the trim aperture. The method for interconnecting a roof rack to a vehicle may include, but is not limited to, selectively securing the roof rack to the front rack member. The roof rack is in the first position of use when secured to the front rack member. The roof rack is rotatable between the first position of use and the second position of use when not secured to the front rack member.

In some embodiments, the method for interconnecting a roof rack to a vehicle may include, but is not limited to, engaging a door clamp member to an A-pillar of the vehicle. The door clamp member has a clamp through-hole. The method for interconnecting a roof rack to a vehicle may include, but is not limited to, selectively securing a medial mount plate of the front rack member to the door clamp member. Selectively securing the medial mount plate may include, but is not limited to, aligning a plate aperture of the medial mount plate with the clamp through-hole of the door clamp member. Selectively securing the medial mount plate may include, but is not limited to, passing a second fastener through the clamp through-hole and into engagement with the plate aperture.

In other embodiments, the lower mounting bracket and/or the clamp member may be selectively securable to the A-pillar by a fastener or rivet that engages an aperture formed in the A-pillar. In some embodiments, securing the lower mounting bracket and/or the clamp member to the A-pillar comprises forming an aperture in the A-pillar.

The following patents and publications, which are all by Badillo, disclose rotatable rack elements and racks with the ability to accommodate lighting features and are hereby each incorporated by reference in their entirety: U.S. Pat. Nos. 8,496,146, 9,676,343, 10,351,070, 10,358,095, 10,829,055, 11,312,311, and U.S. Patent Application 2021/0053503.

For purposes of the present disclosure, it should be understood that a side may be “outward” or away from the vehicle, and “inward” or toward the vehicle, which both correspond to a dimension of length. In addition, it should be understood that an end may be “front” or in the direction of the front of the vehicle, and “rear” or in the direction of the back of the vehicle, which both correspond to a dimension of width. Further, it should be understood that “top” means in the direction of the roof of the vehicle, and “bottom” means in the direction of the ground, which both correspond to a dimension of height or thickness.

For purposes of the present disclosure, components being “selectively securable” or “secured” means to be interconnected with fasteners or rivets, without permanent physical/chemical change, such as realignment of grain structure. In addition, components being “affixed” means to be welded or similarly combined that may potentially cause permanent physical/chemical change, such as realignment of grain structure. Further, components being “coupled” means to be potentially “selectively securable” in some embodiments or potentially “affixed” in other embodiments, as defined above. Further, terminology such as “including” or “comprising” is not intended to impart any limitation on the interconnecting between components.

For purposes of the present disclosure, it should be understood that a “through-hole” includes both an entrance/ingress and an exit/egress. In addition, it should be understood that an “aperture” includes an entrance/ingress or an exit/egress.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 5% of the stated value.

All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The transitional phrase “consisting of” excludes any element, step, or ingredient not specified in the claim, but does not exclude additional components or steps that are unrelated to the disclosure such as impurities ordinarily associated therewith. The transitional phrase “consisting essentially of” limits the scope of a claim to the specified materials or steps and those that do not materially affect the basic and novel characteristic(s) of the claimed invention. The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. In addition, the transitional term “comprising” is synonymous with “including,” “containing,” or “characterized by,” is inclusive or open-ended and does not exclude additional, unrecited elements or method steps.

The preceding is a simplified summary of the disclosure intended to provide an understanding of some aspects of the settler devices of this disclosure. This Summary is neither an extensive nor exhaustive overview of the invention and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below. Further, other embodiments are possible using, alone or in combination, one or more of the features set forth above or described herein. For example, it is contemplated that various features and devices shown and/or described with respect to one embodiment (or one figure) may be combined with or substituted for features or devices of other embodiments (or other figures) regardless of whether or not such a combination or substitution is specifically shown or described herein. Additional aspects of the present invention will become more readily apparent from the Detailed Description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

It should be understood that the drawings are not necessarily (but may be) to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1A is an upper front perspective view of a tower assembly of a roof rack system adapted for use with a vehicle, in accordance with embodiments of the present disclosure;

FIG. 1B is an upper front perspective view of a support tower of the tower assembly according to FIG. 1A;

FIG. 2 is a lower front perspective view of the tower assembly according to FIG. 1A;

FIG. 3 is a front elevation view of the tower assembly according to FIG. 1A;

FIG. 4 is a rear elevation view of the tower assembly according to FIG. 1A;

FIG. 5 is a right (or outer) elevation view of the tower assembly according to FIG. 1A;

FIG. 6 is a left (or inner) elevation view of the tower assembly according to FIG. 1A;

FIG. 7 is a top plan view of the tower assembly according to FIG. 1A;

FIG. 8 is a bottom plan view of the tower assembly according to FIG. 1A;

FIG. 9 is a rear perspective view of the tower assembly according to FIG. 1A provided relative to a vehicle, in accordance with embodiments of the present disclosure;

FIG. 10 is a rear view of a rear rack member, a roof rack, and a tower assembly of a roof rack system provided relative to a vehicle, with the roof rack in a first position of use, in accordance with embodiments of the present disclosure;

FIG. 11 is a right elevation view of the roof rack system according to embodiments of the present disclosure, with the roof rack in the first position of use;

FIG. 12 is a right elevation view of the roof rack system according to FIG. 11, with the roof rack in a second position of use;

FIG. 13 is a right elevation view of the roof rack system according to FIG. 10, with the roof rack in the first position of use;

FIG. 14 is a right elevation view of the roof rack system according to FIG. 13, with the roof rack in a second position of use;

FIG. 15A is a front left perspective view of a front rack member and the roof rack of the roof rack system according to FIG. 10, with the roof rack in the first position of use;

FIG. 15B is a front right perspective view of the front rack member according to FIG. 15A;

FIG. 16A is a left elevation view of the front rack assembly and the roof rack of the roof rack system according to FIG. 15A, with the roof rack in the first position of use;

FIG. 16B is a bottom perspective view of a door clamp assembly of FIG. 16A;

FIG. 17 is a front right perspective view of the front rack assembly and the roof rack of the roof rack system according to FIG. 10, with the roof rack in the first position of use; and

FIG. 18 is a front right perspective view of the front rack assembly and the roof rack of the roof rack system according to FIG. 10, with the roof rack in the second position of use.

Similar components and/or features may have the same reference number. Components of the same type may be distinguished by a letter following the reference number. If only the reference number is used, the description is applicable to any one of the similar components having the same reference number.

To assist in the understanding of the present invention the following list of components and associated numbering found in the drawings is provided herein:

| Number | Component |
|---|---|
| 2 | Tower assembly |
| 4 | Support tower |
| 6 | Frame extension |
| 8 | Clamp |
| 10 | Stabilizer arm |
| 12 | Top plate |
| 14 | Bracket |
| 15 | Bracket axis |
| 16 | Aperture |
| 18 | Neck |
| 20 | Top plate surface |
| 22 | Neck height |
| 24 | Side plate |
| 25 | Bend of metal material |
| 26 | Upper portion |
| 28 | Lower portion |
| 30 | Bottom plate |
| 32 | Bottom plate length |
| 34 | Tower end plate |
| 36 | Tower aperture or through-hole |
| 38 | Extension side plate |
| 40 | Extension connector aperture or through-hole |
| 42 | Tower connector aperture or through-hole |
| 44 | Extension end plate |
| 46 | Clamp flange |
| 48 | Clamp connector aperture or through-hole |
| 50 | Frame extension stabilizer |
| 52 | Extension aperture or through-hole |
| 54 | Stabilizer flange |
| 56 | Stabilizer connector aperture or through-hole |
| 58 | Vehicle |
| 60 | Frame |
| 62 | Gap |
| 64 | Exterior component |
| 66 | Roof rack system |
| 68 | Axle |
| 70 | Roof rack |
| 72 | Rear rack member |
| 74 | Roof |
| 75 | Roof elements |
| 76 | Pivot assembly |
| 78 | Front rack member |
| 79 | Front rack support |
| 80 | Ladder |
| 82 | Windshield |
| 84 | A-pillar |
| 85 | Rub or “wear” plate |
| 86 | Attachment plate |
| 87 | Mount bracket |
| 88 | Rack axis of rotation |
| 90 | Axis defined by the rear axle |
| 91 | Flange |
| 92 | Lower mounting bracket |
| 94 | Bracket through-hole |
| 96 | Trim aperture |
| 98 | Windshield cowling |
| 100 | Sideview mirror arm |
| 102 | Door clamp assembly |
| 104 | Door clamp member |
| 106 | Clamp through-hole |
| 107 | Threaded fastener |
| 108 | Medial mount plate |
| 109 | Nut (back) plate |
| 110 | Plate aperture or through-hole |
| 111 | Cover (outer) plate |
| 112 | Extension plate |
| 114 | Windshield plate member |
| 116 | Upper mount plate aperture or through-hole |
| 118 | Windshield plate member aperture or through-hole |
| 120 | Windshield trim components |

### DETAILED DESCRIPTION

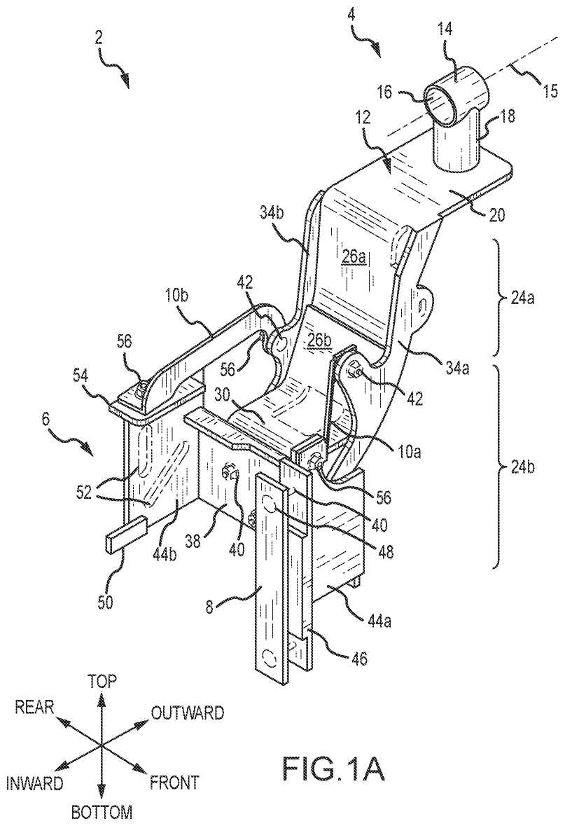

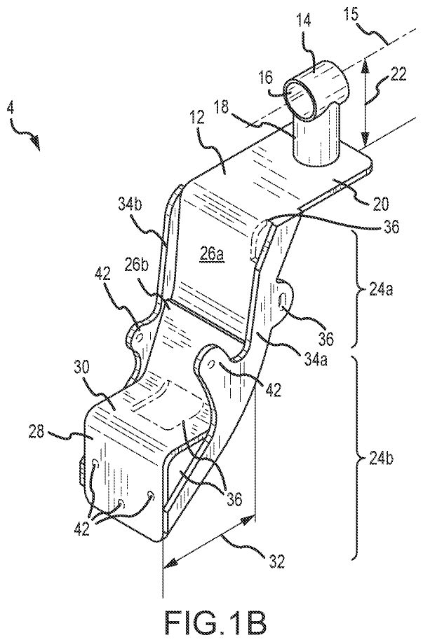

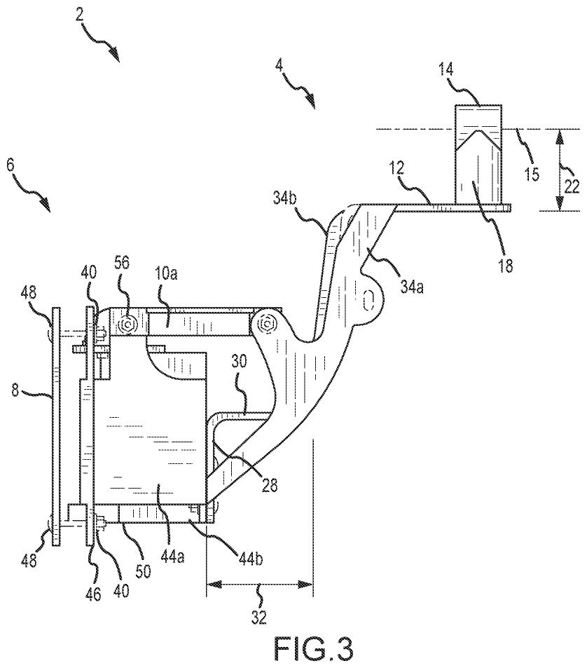

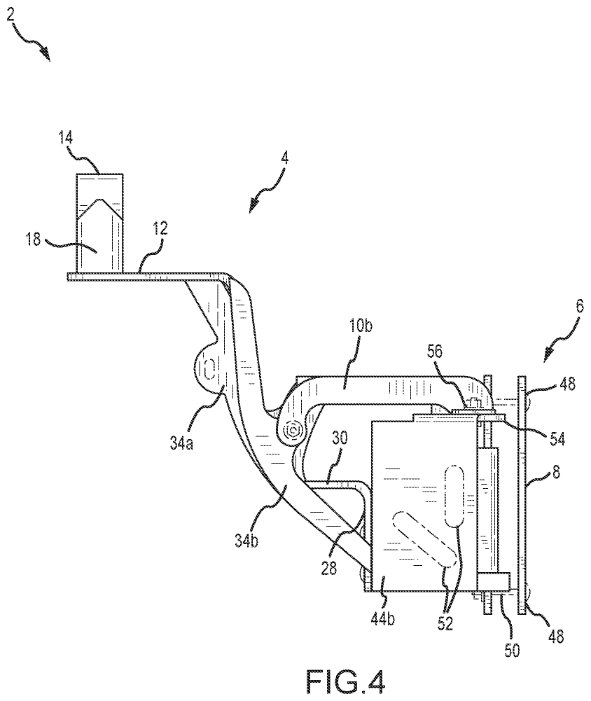

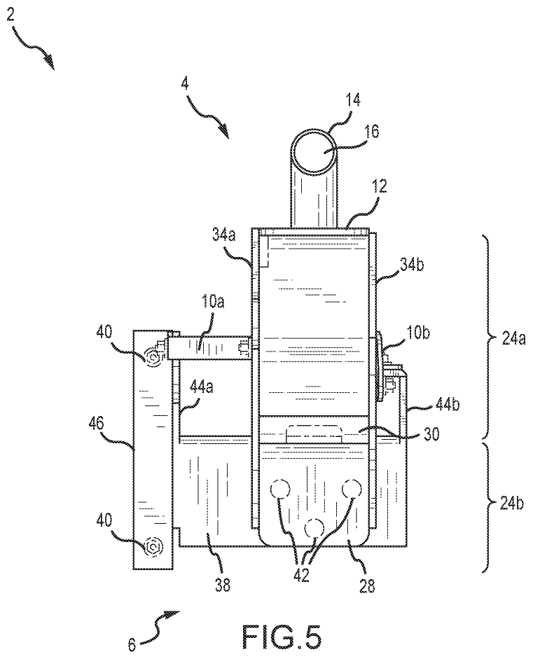

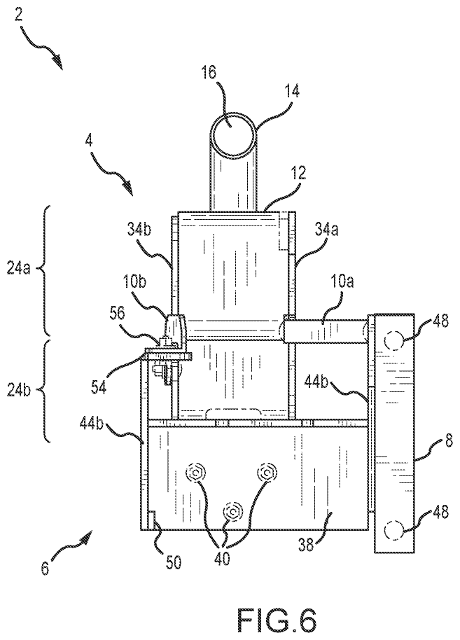

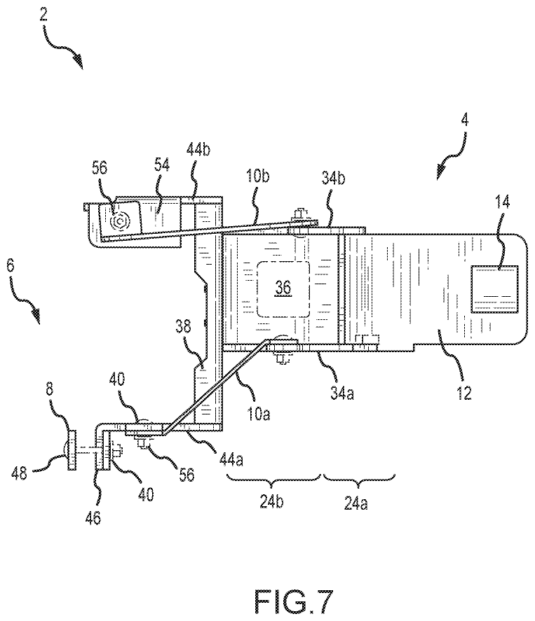

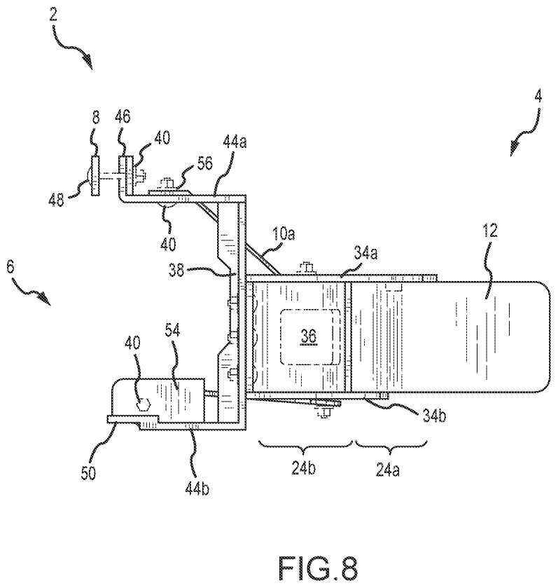

FIGS. 1A-8 depict various views of a tower assembly 2 for a roof rack system 66 adapted for use with a vehicle 58, in accordance with one or more embodiments of the present disclosure. In embodiments, the tower assembly 2 includes a support tower 4, a frame extension 6 coupled to the support tower 4, and a clamp 8 coupled to the frame extension 6. In optional embodiments, the tower assembly 2 includes a stabilizer arm 10a and/or a stabilizer arm 10b, where the stabilizer arms 10a, 10b respectively are selectively coupled to one or more of the support tower 4 and the frame extension 6. Although optional, the support tower stabilizer arms 10a, 10b may be important to prevent the support tower 4 from flexing and bending out away from the vehicle 58 due to weight of the rack and/or of items that are supported by the roof rack 70 when loaded, depending on the vehicle 58 for which the tower assembly 2 is being designed and fabricated to engage. In general, the components 4, 6, 8, 10a, 10b of the tower assembly 2 may be secured together via selective means such as mechanical fasteners (e.g., including bolts, screws, fasteners, rivets, or the like), and/or affixed together via welding, or the like.

In embodiments, the support tower 4 includes a top plate 12. The top plate 12 includes a bracket 14 with an aperture 16. For example, as described herein, the aperture 16 may be operable to receive an axle 68 for pivotably interconnecting a roof rack 70 to the bracket 14. The bracket 14 may be coupled to and extend upwardly from the top plate 12. In one example, the bracket 14 may be coupled to a neck 18, and the neck 18 may be coupled to and extend upwardly from a top plate surface 20 of the top plate 12. For instance, the neck may position an axis 15 of the bracket 14 at a select neck height 22 above the top plate surface 20. In some embodiments, the neck 18 has a shape that is generally cylindrical.

Optionally, the bracket 14 may be coupled directly to the top plate surface 20 with no neck 18. In another example, the bracket 14 may be formed from the top plate 12, including via rolling, crimping, bending, or the like of the top plate 12.

The aperture 16 of the bracket 14 extends along an axis 15. The bracket 14 is configured such that, when the tower assembly 2 is secured to the frame 60 of a vehicle as described herein, the axis 15 extends approximately parallel to an axis 90 defined by a rear axle of the vehicle. Where there are two tower assemblies 2 in the roof rack system 66, the axes 15 through the respective brackets 14 together define an axis of rotation 88 for the roof rack 70, as described herein. Specifically, the bracket apertures 16 of the tower assemblies on the passenger side and the driver's side of the vehicle may be substantially coaxially aligned. In this manner, when a roof rack 70 pivots about the bracket (or brackets) 14 to rotate, the roof rack 70 is aligned with the roof 74 and a front rack member 78 of the vehicle 58 when in a first position of use and unaligned when in a second position of use.

In embodiments, the support tower 4 includes at least one side plate 24 extending downwardly from the top plate 12. The at least one side plate 24 may be formed with the top plate 12 from a single shaped piece of metal. The at least one side plate 24 may be coupled to the top plate 12 (e.g., via selective means for securing, via welding, or the like). In some embodiments, the top plate 12 and the side plate 24 or formed of a single piece of metal which is stamped, pressed or otherwise formed into a predetermined shape.

In one example embodiment, the at least one side plate 24 includes a first side plate 24a and a second side plate 24b formed from multiple shaped pieces of metal. In some embodiments, the first side plate 24a is integrally formed from one piece of a metal material with the top plate 12.

Optionally, the first side plate 24a and/or the second side plate 24b may be formed from multiple shaped pieces of metal. The multiple shaped pieces of metal may be the same thickness or may be different thickness.

Where the tower assembly 2 is fabricated from pieces of metal material with different thicknesses, the different thicknesses may be selected to reduce cost and weight of the tower assembly 2 where possible, while also ensuring adequate or sufficient support of the roof rack 70 (and the roof rack system 66 in general, either unloaded or loaded).

In some embodiments, the first side plate 24a is formed of a metal material with a first thickness and the second side plate 24b is formed of a metal material with a second thickness that is different than the first thickness. In some embodiments, the first thickness is greater than the second thickness.

Optionally, the first thickness is between approximately 0.25 inch and approximately 0.375 inch. In some embodiments, the first thickness is approximately 0.3125 ( 5/16) inch.

The second side plate 24b may have a second thickness of between approximately 0.125 inch and approximately 0.25 inch. In some embodiments, the second thickness is 0.1875 ( 3/16) inch.

This configuration of the support tower with the first and second side plates 24 formed different thicknesses of metal material is beneficial to provide increased stability and rigidity to the tower assembly. More specifically, when the tower assembly 2 is secured to the frame of a vehicle, the first side plate 24a extends outwardly and is further from the vehicle frame than the second side plate 24b. Accordingly, forming the first side plate 24a of a thicker metal material provides increased rigidity and stability to the tower assembly. Although the second side plate 24b could be made of a thicker metal material (such as a metal material with the first thickness), this would unnecessarily increase the cost of the second side plate 24b and make fabrication of the second side plate more difficult. As will be appreciated by one of ordinary skill in the art, it is more difficult to form metal as the thickness of the metal increases.

The first side plate 24a may include a first upper portion 26a that extends from the top plate 12. By way of another example, the first upper portion 26a may be coupled to the top plate 12.

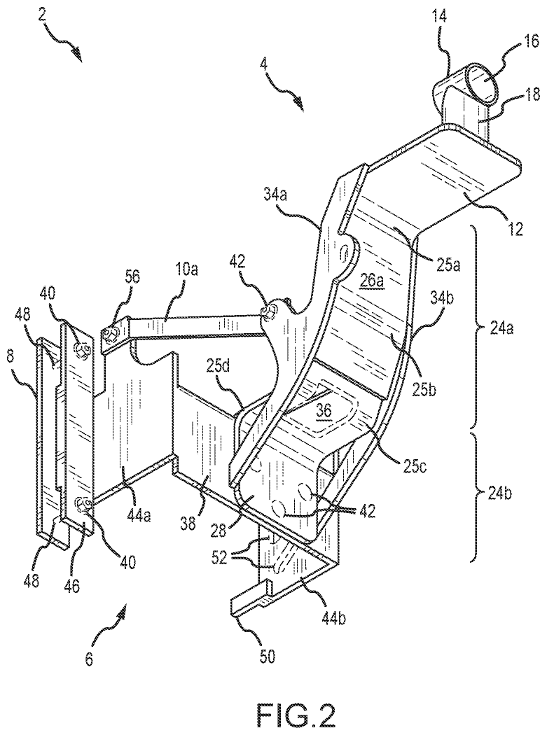

Alternatively, in other embodiments, the first upper portion 26a may be formed from a single shaped piece of metal with the top plate 12. In some embodiments, the first upper portion 26a is connected to the top plate by a first bend 25a of the metal material as shown in FIG. 2. Optionally, the first side plate 24a may also include a second bend 25b.

The second side plate 24b may include a second upper portion 26b. As shown in FIG. 2, in some embodiments the second side plate 24b includes a third bend 25c and optionally a fourth bend 25d.

The second upper portion 26b may be coupled to and extend from the first upper portion 26a of the first side plate 24a. For example, in some embodiments, the first and second side plates are welded together from two pieces of material at the first and second upper portions. Forming the first and second side plates 24a, 24b of two separate pieces of metal material improves the fabrication process by decreasing the time required to form the support tower 4 into a predetermined shape. In some embodiments, the predetermined shape of the support tower 4 includes the top plate surface 20 being approximately perpendicular to an inward surface of the lower portion 28 of the support tower. Said differently, a first reference plane defined by the top plate surface 20 is approximately, or substantially, perpendicular to a second reference plane defined by the inward surface of the lower portion 28.

In some embodiments, the support tower 4 is formed on a jig. When forming the support tower and its four bends 25a, 25b, 25c, 25d, if the first and second side plates 24a, 24b are formed of a single piece of metal material, any error in the angles of the bends accumulates into subsequent bends. Thus, the top plate surface 20 may not be in the predetermined alignment with the inward surface of the lower portion 28.

In contrast, by forming the first side plate 24a with two bends 25a, 25b and the second side plate 24b with two bends 25c, 25d, when the side plates 24a, 24b are welded together, any error in the bends 25 may be compensated for by altering the alignment (or degree of overlap) between the first and second side plates 24a, 24b. In this manner, the time required to achieve the final shape of the support tower is reduced.

In one example embodiment, the first upper portion 26a and the second upper portion 26b may at least partially overlap to further increase the thickness of the support tower 4 within the section of overlap and increase the rigidity of the support tower 4 (and thus the tower assembly 2). Overlapping two pieces of metal with reduced thickness and affixing via welding may result in a slightly higher cost of manufacturing than providing a single piece of metal with equal or greater thickness than the combined thickness of the overlapping pieces of metal, but still reduces material cost and weight of the tower assembly 2 as a whole.

The second side plate 24b may include a lower portion 28 and a bottom plate 30. For example, the second upper portion 26b, the lower portion 28, and/or the bottom plate may be formed from a single shaped piece of metal. In the alternative, the second upper portion 26b, the lower portion 28, and/or the bottom plate 30 may be coupled together.

The bottom plate 30 may be positioned within the second side plate 24b such that the lower portion 28 is coupled to the second upper portion 26b via the bottom plate 30. In this regard, the lower portion 28 may be offset from the second upper portion 26b (and thus offset from the first side plate 24a) a select bottom plate length 32 defined by the bottom plate 30. For example, the offsetting may cause the top plate 12 to be offset a select distance outward relative to the lower portion 28. The offsetting of the lower portion 28 from the second upper portion 26b may be to at least partially conform the support tower 4 (and the tower assembly 2, in general) to a frame 60 and/or exterior components of the vehicle 58, as described herein. It is noted, however, a single side plate 24 may not include offsetting, without departing from the scope of the present disclosure.

Optionally, the support tower 4 may include at least one tower end plate 34 extending to the front and/or to the rear of the at least one side plate 24 to further increase rigidity of the support tower 4 (and thus the tower assembly 2). The at least one tower end plate 34 may be formed with the top plate 12 and/or the at least one side plate 24 from a single shaped piece of metal. In some embodiments, the at least one tower end plate 34 may be coupled to the top plate 12 and/or the at least one side plate 24 (e.g., via selective means for securing, via welding, or the like).

In one example embodiment, the at least one tower end plate 34 includes a first tower end plate 34a and a second tower end plate 34b. In another example embodiment, the at least one tower end plate 34 may include a single tower end plate 34.

The end plates 34a, 34b may be formed of separate pieces of metal material that are welded to the at least one side plate 24 and/or to the top plate 12. In some embodiments, one or more of the end plates 34a, 34b are formed of a metal material with a third thickness. The third thickness is optionally different from one or more of the first thickness of the first end plate 24a and the second thickness of the second end plate 24b. Optionally, the third thickness is between approximately 0.0625 inch and approximately 0.1875 inch. In at least one embodiment, the third thickness is approximately 0.125 inch.

In some embodiments, the top plate 12, the at least one side plate 24, the bottom plate 30, and/or the at least one end plate 34 includes one or more tower apertures or through-holes 36. For example, the tower apertures or through-holes 36 may correspond to apertures or through-holes on the vehicle 58, such as on the frame 60 of the vehicle 58. By way of another example, the tower apertures or through-holes 36 may correspond to apertures or through-holes on other portions of the tower assembly 2. Further, the tower apertures or through-holes 36 may be for weight reduction of the tower assembly 2.

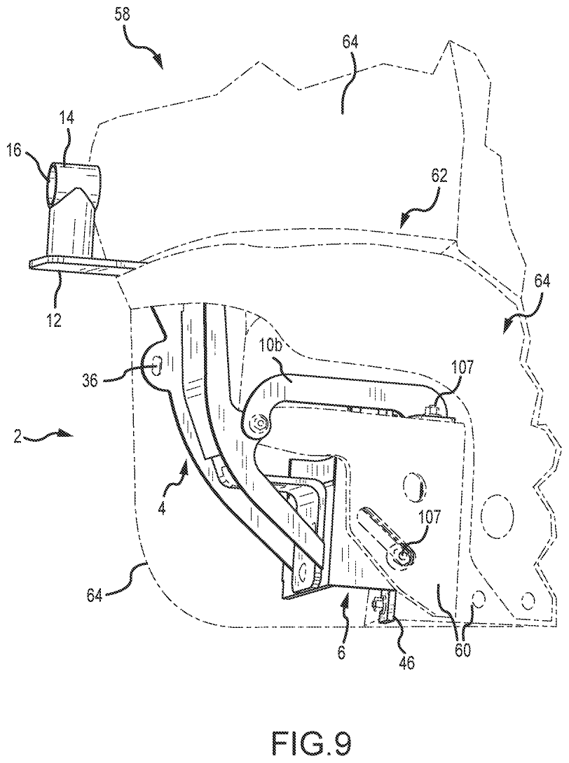

In some embodiments, a through-hole 36 in the first tower end plate 34a (illustrated in FIGS. 1B and 9) is adapted to receive a backup sensor of the vehicle 58. More specifically, during installation of the tower assembly, the backup sensor may be disconnected from a portion of the frame 60 of the vehicle. After the tower assembly 2 is fixed to the frame (in some embodiments, at least partially within a rear vehicle isolator body of the vehicle) the backup sensor may be positioned within the through-hole 36 to properly align the backup sensor relative to the rear of the vehicle.

In embodiments, the frame extension 6 includes an extension side plate 38. For example, the extension side plate 38 may include one or more extension connector apertures or through-holes 40 operable to interface with corresponding tower connector apertures or through-holes 42 on the lower portion 28 of the support tower 4. For instance, the extension connector apertures or through-holes 40 and the tower connector apertures or through-holes 42 may be operable to receive fasteners, rivets, or other selective means to secure the frame extension 6 to the support tower 4. By way of another example, the frame extension 6 may be affixed to the support tower 4, including via welding, in addition to or instead of the selective means for securing described above. When the frame assembly is secured or coupled to the vehicle, the fasteners may extend through the through-holes 40 of the support tower, through the through-holes 42 of the extension side plate 38, and through aligned holes in the vehicle frame.

In embodiments, the frame extension 6 includes at least one extension end plate 44 at one or more of the front and the rear of the extension side plate 38. The at least one extension end plate 44 may be formed with the extension side plate 38 from a single shaped piece of metal. The at least one extension end plate 44 may be coupled to the extension side plate 38 (e.g., via selective means for securing, via welding, or the like).

In one example embodiment, the at least one extension end plate 44 includes a first extension end plate 44a and a second extension end plate 44b. The first extension end plate 44a and/or the second extension end plate 44b may be each formed from a single shaped piece of metal or formed from multiple shaped pieces of metal.

The frame extension 6 includes a clamp flange 46 extending from the first extension end plate 44a. The clamp flange 46 may be formed with the first extension end plate 44a from a single shaped piece of metal. Alternatively, in some embodiments, the clamp flange 46 is coupled to the first extension end plate 44a (e.g., via selective means for securing, via welding, or the like).

The clamp flange 46 is configured and operable to interface with the clamp 8. For example, the clamp flange 46 may include one or more extension connector apertures or through-holes 40 operable to interface with corresponding clamp connector apertures or through-holes 48 on the clamp 8. For instance, the extension connector apertures or through-holes 40 and the clamp connector apertures or through-holes 48 may be operable to receive fasteners, rivets, or other selective means to secure the clamp 8 to the frame extension 6. By way of another example, the clamp 8 may be affixed to the frame extension 6, including via welding, in addition to or instead of the selective means for securing described above

In some embodiments, the frame extension 6 includes a frame extension stabilizer 50 extending from the second extension end plate 44b. The frame extension stabilizer 50 may be formed with the second extension end plate 44b from a single shaped piece of metal. Alternatively, frame extension stabilizer 50 may be coupled to the second extension end plate 44b (e.g., via selective means for securing, via welding, or the like). In one example embodiment, the frame extension stabilizer is configured to engage a planar portion of the vehicle frame when the tower assembly 2 is secured to the frame 60. As will be appreciated by one of skill in the art, the vehicle frame 60 may include an uneven surface which includes welds or other protrusions. Accordingly, if the frame extension did not include the frame extension stabilizer 50, an inward end or edge of the second extension end plate 44b might contact a protrusion or weld on the frame and rock or rotate relative to the frame. In contrast, the frame extension stabilizer 50 extends inwardly beyond the inward end of the second extension end plate 44b to make contact with a planar portion of the frame. In this manner, the contact of the frame extension stabilizer 50 with the frame separates the inward end of the second extension end plate 44b from the frame by a predetermined amount. The contact of the frame extension stabilizer with the frame thus improves stability of the tower assembly with respect to the frame and also improves alignment of the tower assembly with the vehicle.

It some embodiments, the extension side plate 38, the first extension end plate 44a, and/or the second extension end plate 44b include one or more extension apertures or through-holes 52. For example, the extension apertures or through-holes 52 may correspond to apertures or through-holes on the vehicle 58, such as on the frame 60 of the vehicle 58 (e.g., as illustrated in FIG. 9). When present, a bolt or hex head screw may extend through the through-hole 52 and a corresponding aperture through the frame 60 to help secure the tower assembly 2 to the vehicle. By way of another example, the extension apertures or through-holes 52 may be to accommodate the stock bumper of the vehicle 58 and/or aftermarket bumpers designed for the vehicle 58. Further, the extension apertures or through-holes 52 may correspond to apertures or through-holes on other portions of the tower assembly 2. Further, the extension apertures or through-holes 52 may be for weight reduction of the tower assembly 2.

Optionally, the frame extension 6 may include a stabilizer flange 54 extending from the second extension end plate 44b. The stabilizer flange 54 may be formed with the second extension end plate 44b from a single shaped piece of metal. Alternatively, the stabilizer flange 54 may be coupled to the second extension end plate 44b (e.g., via selective means for securing, via welding, or the like).

In optional embodiments, the first stabilizer arm 10a may be coupled to the support tower 4 and the frame extension 6. For example, the first stabilizer arm 10a may be coupled to the first tower end plate 34a of the support tower 4 and the first extension end plate 44a of the frame extension 6. For example, the first stabilizer arm 10a may include one or more stabilizer connector apertures or through-holes 56 operable to interface with corresponding tower connector apertures or through-holes 42 on the first tower end plate 34a and/or with corresponding extension connector apertures or through-holes 40 on the first extension end plate 44a. For instance, the stabilizer connector apertures or through-holes 56, extension connector apertures or through-holes 40, and/or the tower connector apertures or through-holes 42 may be operable to receive fasteners (such as a threaded bolt), rivets, or other selective means to secure the first stabilizer arm 10a to the support tower 4 and/or the frame extension 6. Alternatively, in other embodiments, the first stabilizer arm 10a may be affixed to the first end plate 34a and/or the first extension end plate 44a, including via welding, in addition to or instead of the selective means for securing described above.

In optional embodiments, the second stabilizer arm 10b may be coupled to the support tower 4 and the frame extension 6. For example, the second stabilizer arm 10b may be coupled to the second tower end plate 34b of the support tower 4 and the stabilizer flange 54 of the second extension end plate 44b of the frame extension 6. For example, the second stabilizer arm 10b may include one or more stabilizer connector apertures or through-holes 56 operable to interface with corresponding tower connector apertures or through-holes 42 on the second tower end plate 34b and/or with corresponding extension connector apertures or through-holes 40 on the stabilizer flange 54. For instance, the stabilizer connector apertures or through-holes 56, extension connector apertures or through-holes 40, and/or the tower connector apertures or through-holes 42 may be configured and operable to receive fasteners (such as a threaded bolt), rivets, or other selective means to secure the second stabilizer arm 10b to the support tower 4 and/or the frame extension 6. In one or more alternative embodiments, the second stabilizer arm 10b may be affixed to the second end plate 34b and/or the stabilizer flange 54, including via welding, in addition to or instead of the selective means for securing described above. In some embodiments, a fastener 107 may extend through the through-hole 40 of the stabilizer flange, through an aligned aperture of the vehicle frame, and through an aligned through-hole 56 of the second stabilizer arm 10b to help secure the tower assembly to the vehicle as generally illustrated in FIG. 9.

Although embodiments of the disclosure are directed to select flanges extending from the support tower 4 and/or the frame extension 6 for the stabilizer arms 10a, 10b, it is noted that the tower assembly 2 may be operable to receive the stabilizer arms 10a, 10b directly and without need for additional flanges. As such, the above description should be regarded as merely an illustration and should not be interpreted as limiting to the present disclosure.

It is noted that the components and sub-components of the tower assembly 2 may be set at any angle relative to one another when the tower assembly 2 is assembled. In one non-limiting example, the plates 12, 24, 34 of the support tower 4 may be parallel or approximately parallel to one another, perpendicular or approximately perpendicular to one another, or set at oblique angles to one another. It is noted the angles may be dependent on the vehicle 58 for which the tower assembly 2 is being designed and fabricated.

By way of another example, the stabilizer arms 10a, 10b may be parallel or approximately parallel to one another, perpendicular or approximately perpendicular to one another, or set at oblique angles to the support tower 4, the frame extension 6, and/or to each other. For instance, the second stabilizer arm 10b may be set at an oblique angle relative to the first stabilizer arm 10a.

In some embodiments, the axis 15 of the bracket aperture 16 is oriented approximately parallel to the top plate surface 20. The top plate surface 20 is optionally approximately perpendicular to the first upper portion 26a of the first side plate 24a. Alternatively, the first upper portion 26a is oriented at an oblique angle to the top plate surface 20.

In at least one embodiment, an upper surface of the bottom plate 30 of the second side plate 24b is approximately parallel to the top plate surface 20. The bottom plate 30 is optionally approximately perpendicular to the second upper portion 26b of the second side plate 24b. Alternatively, the bottom plate 30 is oriented at an oblique angle to the second upper portion 26b. The lower portion 28 may optionally be approximately perpendicular to the upper surface of the bottom plate 30. Accordingly, in some embodiments the lower portion 28 is approximately parallel to the first upper portion 26a. Alternatively, in some embodiments the lower portion 28 is oriented at an oblique angle to the first upper portion 26a.

In some embodiments, the extension side plate 38 of the frame extension 6 is generally planar. In addition, the first and second extension end plates 44a, 44b may optionally be generally planar.

Optionally, the first extension end plate 44a is approximately perpendicular to the lower portion 28, the bottom plate 30, and/or the extension side plate 38. Additionally, or alternatively, the second extension end plate 44b is approximately perpendicular to the lower portion 28, the bottom plate 30, and/or the extension side plate 38. Accordingly, in some embodiments the first and second extension end plates 44a, 44b may be described as being approximately parallel.

The clamp flange 46 may be approximately perpendicular to the first extension end plate 44a. Alternatively, the clamp flange 46 may be oriented at an oblique angle to the first extension end plate 44a. In some embodiments the clamp flange 46 extends from an inner end of the first extension end plate 44a.

The stabilizer flange 54 may be positioned at an upper end of the second extension end plate 44b. In some embodiments, the stabilizer flange 54 is oriented approximately perpendicular to the second extension end plate 44b. Alternatively, the stabilizer flange 54 may be oriented at an oblique angle to the second extension end plate 44b.

The frame extension stabilizer 50 may be generally planar. In some embodiments, the frame extension stabilizer 50 extends inwardly past an inward edge of the second extension end plate 44b. Optionally, the frame extension stabilizer is fixed to a forward facing surface of the second extension end plate 44b. Alternatively, the frame extension stabilizer 50 may be fixed to a surface of the second extension end plate 44b that faces rearwardly.

FIGS. 9-16 include various views of the roof rack system 66, in accordance with embodiments of the present disclosure. In one non-limiting example, the roof rack system 66 includes two tower assemblies 2, the roof rack 70, a rear rack member 72, a front rack member 78, and a door clamp assembly 102.

Referring now to at least FIG. 9, securing the clamp 8 to the frame extension 6 (e.g., via engagement of a fastener) may reduce or decrease a distance between the frame extension 6 and the clamp 8, and selectively secures the tower assembly to the frame 60 of the vehicle 58. The clamp 8 may be selectively positionable adjacent to an inward portion of the frame 60 and the clamp flange 46 of the first extension end plate 44a is selectively positionable adjacent to an outward portion of the frame 60 prior to engagement of the fastener. The clamp 8 is drawn toward the frame 60 and the frame extension 6 to decrease the distance between the frame extension 6 and the clamp 8 during engagement of a first fastener.

In this regard, the tower assembly 2 is securable to the frame 60 without modification of the frame 60. In general, the tower assembly 2 is securable to the vehicle 58 without modification of the vehicle 58 including, but not limited to, cutting, drilling, grinding, or the like. For example, at least a portion of the support tower 4 including the bracket 14 is capable of extending through a gap 62 between adjacent exterior components 64 of the vehicle 58 when the tower assembly 2 is secured to the frame 60 of the vehicle 58 via the frame extension 6 and the clamp 8.

Optionally, the support tower 4, the frame extension 6, and the stabilizer arms 10a, are adjustable relative to one another to reduce interference between the tower assembly 2 and the frame 60 or at least one of the adjacent exterior components 64 of the vehicle 58. For example, the exterior components 64 may include, but are not limited to, adjacent body panels such as quarter panels, bumpers, bumper covers, or other exterior components positioned proximate to a lower rear portion of the vehicle 58. It is noted that to “reduce interference” means to prevent unnecessary or unwanted contact that may lead to rubbing, grinding, or other interfacing between components resulting in increased wear of the tower assembly 2 and the exterior components 64 and/or frame 60 of the vehicle 58.

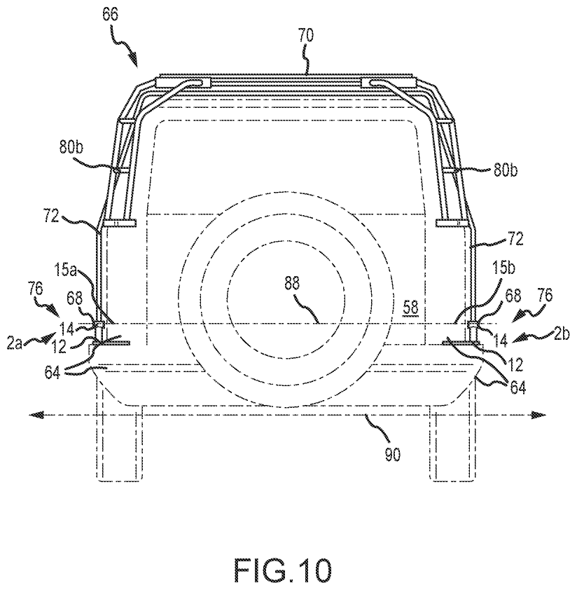

Referring now to FIGS. 10-14, in embodiments the aperture 16 of the bracket 14 is operable to receive the axle 68 for pivotably interconnecting the roof rack 70 to the bracket 14. For example, the roof rack 70 may include a rear rack member 72 which may couple to the bracket 14 via the axle 68. By way of another example, the roof rack 70 may directly couple to the bracket 14 via the axle 68 (e.g., the rear rack member 72 is integrated into the roof rack 70 design, and a separate attachable component). It is noted that the axle 68 may include, but is not limited to, a pin, fastener, threaded or unthreaded rod, or the like. In addition, it is noted that the bracket 14, the axle 68, and any bushings, bearings, or other fasteners necessary to couple the roof rack 70 to the bracket 14 may be considered components of a pivot assembly 76, for purposes of the present disclosure.

The roof rack 70 is rotatable between a first position of use and a second position of use about a common axis of rotation 88 extending through the bracket 14 and the axle 68 of the pivot assembly 76 when the roof rack 70 is pivotably interconnected to the bracket 14. As illustrated in FIG. 10, the axis of rotation 88 is coaxial with the axes 15a, 15b of first and second tower assemblies 2a, 2b connected to the vehicle frame.

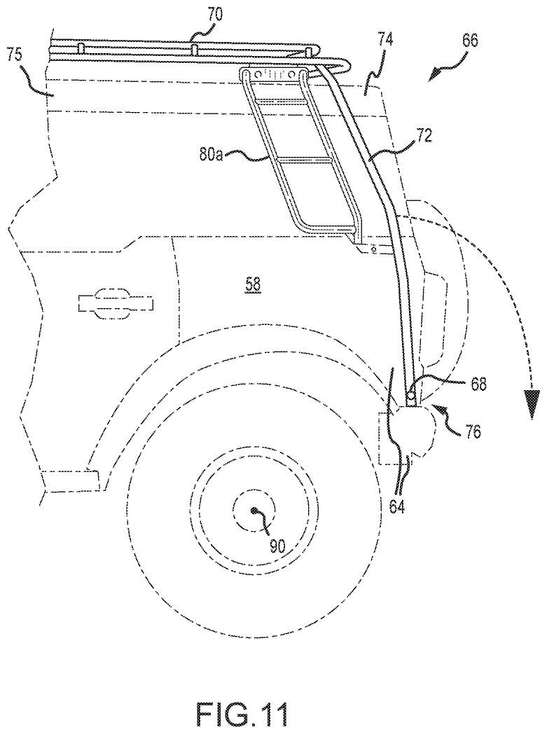

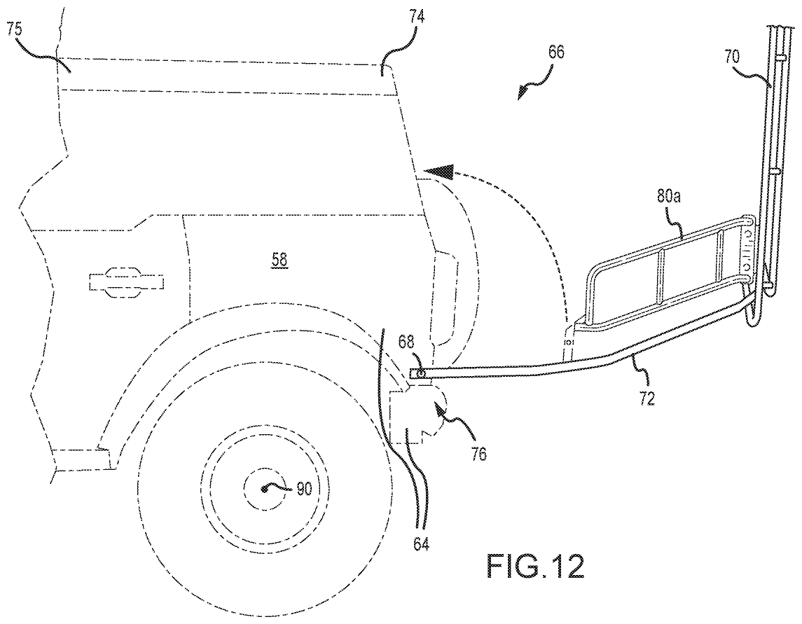

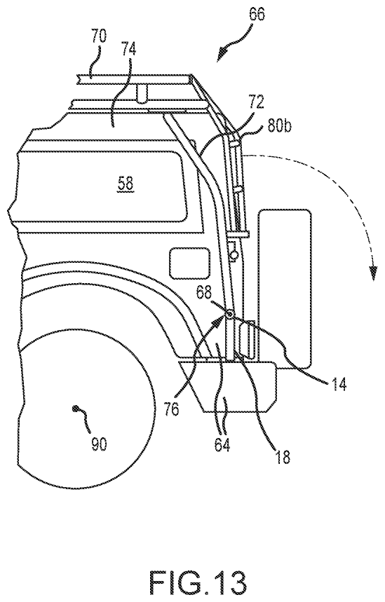

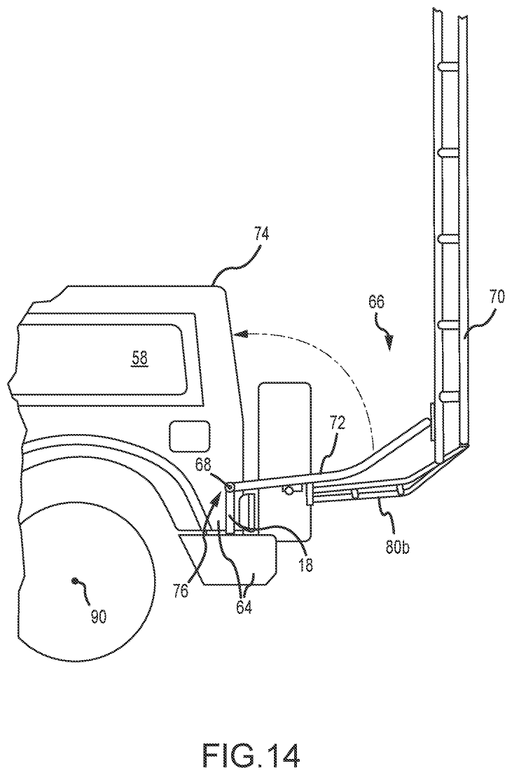

As illustrated in FIGS. 11 and 13, the first position of use is when the roof rack 70 is rotated toward the front of the vehicle 58, such that the roof rack 70 is operable to be secured to a front rack member 78. In this first position, the roof rack 70 is oriented parallel or approximately parallel to a roof 74 of the vehicle 58, and roof elements 75 of the roof 74 are not accessible. By way of another example, as illustrated in FIGS. 12 and 14, the second position of use is when the roof rack 70 is rotated away from the roof and the rear of the vehicle 58. In this first position, the roof rack 70 is oriented at an oblique angle or is oriented perpendicular or approximately perpendicular to the roof 74 of the vehicle 58, and the roof elements 75 of the roof 74 are accessible for installation, removal, opening, and/or closing.

One of skill in the art will recognize that the scope of the invention(s) of the present disclosure are not limited to a particular hinge or pivot point such as that through the pivot assembly 76, and that various pivot points may be provided without deviating from the scope and spirit of the disclosure.

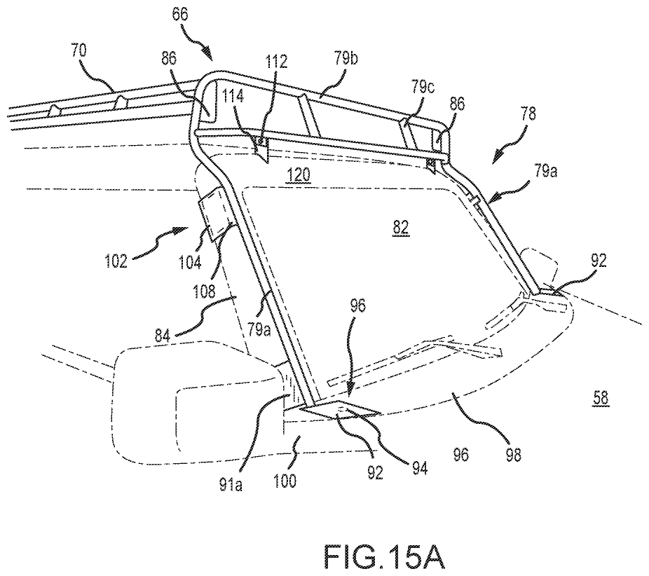

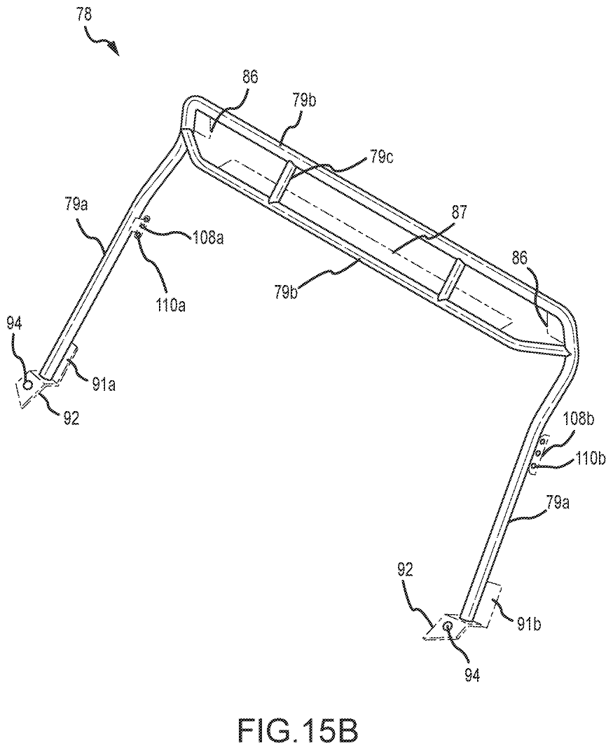

Although not illustrated, the roof rack system 66 may include one or more inserts for interconnection with the supports of the roof rack 70. The one or more inserts may be coupled to the roof rack 70 via fasteners, an engagement of mount brackets 87 on the supports 79 (which are illustrated in FIG. 15B) with tabs on the inserts, or the like. The one or more inserts may be removable and insertable to allow for a reduction of weight prior to transition the roof rack 70 between the first position of use and the second position of use. The one or more inserts may be removable and insertable to allow for increased sunlight to pass through the roof rack 70 (e.g., when the hard panel roof elements 75 are removed from the roof 74, or when the soft or convertible roof elements 75 are opened on the roof 74). It is noted, however, that at least some of the inserts may be affixed to the supports of the roof rack 70 (e.g., via welding), and are thus not removable and insertable.

Optionally, the roof rack system 66 may include a ladder 80. For example, the ladder 80 may be coupled to one or more of the roof rack 70 and/or the rear rack member 72. FIGS. 11 and 12 depict an example embodiment of a ladder 80a that is positioned forward of the rear rack member 72. In addition, FIGS. 10, 13, and 14 depict another example embodiment of a ladder 80b that is positioned rearward of the rear rack member 72. The ladders 80 may be configured to conform to exterior body styling of the vehicle 58. In this regard, the ladders 80 may not make contact with the exterior components 64 and/or the roof elements 75 of the vehicle 58. It is noted, however, the ladder 80 may be operable to attach and/or otherwise engage the vehicle 58 at one or more points of contact (e.g., rest on the exterior components 64, be mounted to the exterior components 64 at mount points, or the like), without departing from the scope of the present disclosure.

The ladder 80 (and the roof rack system 66 in general) does not interfere with any moving or stationary part of the vehicle 58 such as a swing gate tire carrier, rear tail lights, rear window openings, rear hatch back, or the like. For example, as generally illustrated in FIG. 10, the ladders 80 and rear rack member 72 are configured such that they do not interfere with operation of a rear window of a vehicle 58. More specifically, in at least some embodiments, a left side ladder 80b is separated from a right side ladder 80b by a first distance that is greater than a width of the rear window. Further, the left portion of the rear rack member 72 is separated from a right portion of the rear rack member 72 by a second distance that is greater than a width of the rear door of the vehicle. In this manner, the rear window and the rear door may operate (as by rotating up or down relative to the vehicle) without restriction or interference from the roof rack system 66 or any of its components.

Referring now to FIGS. 15-18, in embodiments the roof rack system 66 includes the front rack member 78 with support 79. The front rack member 78 is associated with the vehicle 58 and positioned adjacent to a windshield 82 and an A-pillar 84 of the vehicle 58. For example, the front rack member 78 includes a first set of supports 79a contoured to conform to the A-pillar 84, and a second set of supports 79b coupled to the first set of supports 79a and that extend across the roof 74. It is noted the second set of supports 79b may be generally horizontal when the front rack member is installed on the vehicle 58. In addition, it is noted a third set of supports or stabilizing members 79c may be coupled to or between the second set of supports 79b and/or the first set of supports 79a for additional strength and rigidity. In one non-limiting example, the front rack member 78 may include a pair of supports 79a aligned with side edges of the windshield 82, a second pair of stacked supports 79b positioned across the roof 74 with at least one support 79b aligned with a top edge of the windshield 82, and a third set of supports 79c coupled between the second pair of stacked supports 79b. It is noted the sets of supports 79 may include one or more straight sections and/or one or more arcuate sections along the respective lengths, which may increase the contouring to the A-pillar 84 and the windshield 82 in an effort to reduce or minimize visual obstructions to a driver of the vehicle 58.

The roof rack 70 is selectively securable to the front rack member 78 (e.g., via fasteners, or the like). As depicted in FIGS. 10, 11, 13, and 15-17, the roof rack 70 is in the first position of use when secured to the front rack member 70. As depicted in FIGS. 12, 14 and 18, the roof rack 70 is rotatable between the first position of use and the second position of use when not secured to the front rack member 78.

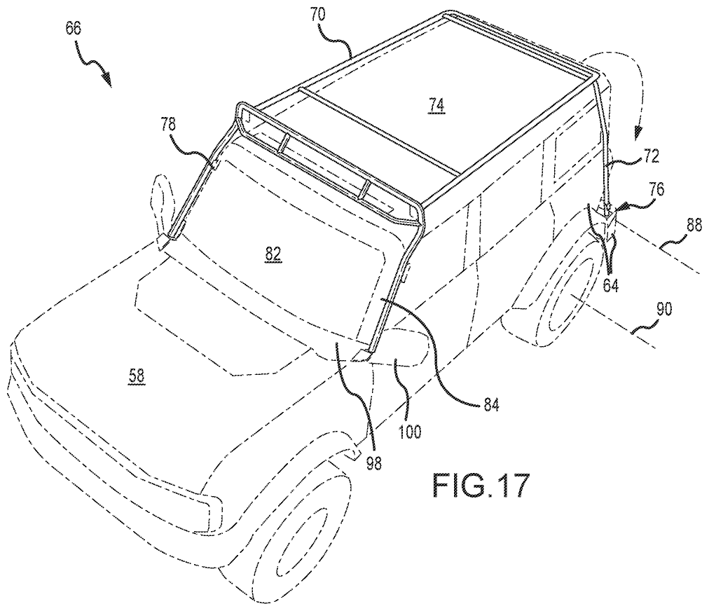

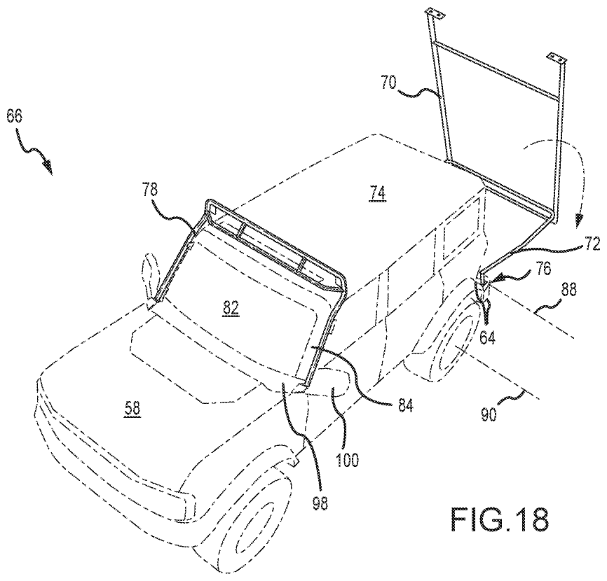

The front rack member 78 may include at least one attachment plate 86 provided to selectively secure the roof rack 70 to the front rack member 78. In one example embodiment, the roof rack 70 is selectively rotatable by uncoupling a connection to the attachment plates 86 (e.g. where attachment plates 86 are coupled to a roof rack 70 with fasteners, which are removable), and rotating the roof rack 70 rearward about the axis of rotation 88 that extends through the pivot assembly 76 coupling the roof rack 70 to the tower assembly 2. In one non-limiting example, as illustrated in FIGS. 17 and 18, the axis of rotation 88 is parallel or approximately parallel to an axis 90 (or axis of rotation of the wheels) defined by a rear axle of the vehicle 58.

The front rack member 78 may include additional attachment plates, mount brackets 87, apertures or through-holes, or other means to couple accessories such as fog lights or driving lights, light bars, tie-down straps or hooks, and the like to the front rack member 78. The lights or other equipment may require access to a source of power and/or control toggles or switches. As such, the front rack member 78 may include exterior mount points (e.g., tie-downs, hooks, recesses or grooves, and the like) on the supports 79 and/or may include access points (e.g., apertures or through-holes) to a hollow interior within the supports 79 to assist in the running of wiring.

The front rack member 78 includes at least one means for attaching to the vehicle 58 proximate or adjacent to the windshield 82 and the A-pillar 84 of the vehicle 58.

In one non-limiting example, the front rack member 78 includes a lower mounting bracket 92 with a bracket through-hole 94 that is capable of aligning with a trim aperture 96 in a trim piece of the vehicle 58 proximate to the windshield 82. For example, the trim piece may be a windshield cowling 98. By way of another example, the trim piece may be a sideview mirror arm 100. In one non-limiting example, the lower mounting bracket 92 is at least contoured to conform to and is capable of resting on top of the trim piece. By way of another example, the lower mounting bracket 92 may in addition include a section that comes into contact with the A-pillar 84. It is noted the lower mounting bracket 92 may be selectively securable to the A-pillar 84 and/or may include contact members that engage the A-pillar 84, as described herein.

In some embodiments, the front rack member 78 may include a flange 91 that comes into contact with the A-pillar 84 as generally illustrated in FIG. 15A. The flange 91 may frictionally engage the A-pillar 84. In some embodiments, the flange 91a on the right side of the front rack member 78 is spaced from the flange 91b on the left side by a distance that is less than the distance between corresponding portions of the A-pillars. Accordingly, during installation of the front rack member, the front rack supports 79a must be pulled outwardly away from each other to provide space for the flanges 91 to fit over the A-pillars. Then when the flanges 91 are in position relative to the A-pillars, the front rack supports 79a may be released so that the flanges 91 may frictionally engage the A-pillars.

The flanges 91 are optional. However, when present, the flanges are beneficial during installation of the front rack member 72 on the vehicle as frictional engagement of the flanges 91 with the vehicle 58 helps to align the front rack member relative to the vehicle. Moreover, the flanges 91 also help prevent unintended or inadvertent movement of the front rack member relative to the vehicle before fasteners and clamps are used to secure the front rack member to the vehicle as described herein.

The lower mounting bracket 92 is selectively securable to the trim piece via a fastener passed through the bracket through-hole 94 of the lower mounting bracket 92 and into the trim aperture 96. It is noted the lower mounting bracket 92 may wrap on (or contact) at least two sides of the trim piece (e.g., on a top surface for the alignment and acceptance of the fastener, and on a rearward surface proximate to the windshield 82). Wrapping on the at least two sides may prevent the front rack member 78 from disengaging the fastener and sliding forward along the trim piece away from the windshield 82 and A-pillar 84. It is noted the sliding may potentially cause the roof rack system 66 to apply additional or unnecessary force on the interconnection between the roof rack 70 and the front rack member 78 at the attachment plates 86, which may prematurely weaken the interconnection. In addition, it is noted this placement of the lower mounting bracket 92 is above (or rearward of) the hood of the vehicle 58, and as such does not interfere with the operation of the hood.

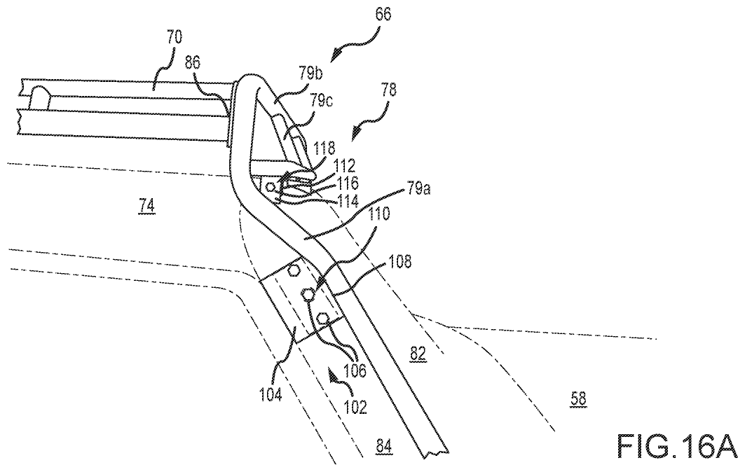

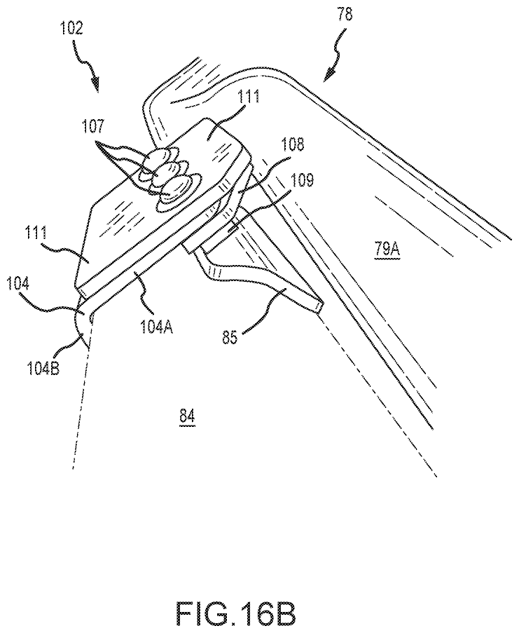

Referring now to FIGS. 16A and 16B, in another non-limiting example, the front rack member 78 includes a door clamp assembly 102. The assembly 102 includes a door clamp member 104 that is couplable to the A-pillar 84 of the vehicle 58 and that includes a clamp through-hole 106. Optionally, the member 104 has three through-holes 106.

In some embodiments, the clamp member 104 includes a planar portion 104A and a curved portion 104B configured to frictionally engage the A-pillar 84. In this manner, the clamp member 104 may be attached to the A-pillar and the vehicle 58 without cutting or drilling into the vehicle 58. The clamp through-hole 106 is formed through the planar portion 104A. The curved portion 104B extends from an end of the planar portion 104A toward a rear of the vehicle 58 when installed. In some embodiments, the clamp member 104 is positioned under a window gasket associated with the A-pillar. For example, at least the curved portion 104B may be positioned at least partially between the window gasket and the A-pillar 84.

In other embodiments, the lower mounting bracket 92 and/or the clamp member 104 may be selectively securable to the A-pillar by a fastener or rivet that engages an aperture formed in the A-pillar. In some embodiments, securing the lower mounting bracket 92 and/or the clamp member 104 to the A-pillar comprises forming an aperture in the A-pillar.

The assembly 102 includes a medial mount plate 108 coupled to the front rack member 78. In some embodiments, the medial mount plate 108 is welded to the front rack member 78. The medial mount plate 108 includes a plate aperture 110 (depicted as a dashed-line circle in FIG. 16A) that is capable of aligning with the clamp through-hole 106 of the door clamp member 104. The medial mount plate 108 is selectively securable to the door clamp member 104 via a threaded fastener 107 passed through the clamp through-hole 106 of the door clamp member 104 and engaged to the plate aperture 110 of the medial mount plate 108. In some embodiments, the plate aperture 110 of the medial mount plate 108 is threaded. Accordingly, the threaded fastener 107 may engage threads of the plate aperture 110.

Alternatively, in other embodiments the plate aperture 110 may be a plate through-hole 110 which is unthreaded. In these embodiments, the fastener passes through the plate through-hole 110 and engages a nut or other fixture on the opposite side.

Forming the plate aperture 110 as an unthreaded through-hole is beneficial. Specifically, the unthreaded through-hole 110 may have a greater diameter than the threaded shaft of the threaded fastener 107. Moreover, in some embodiments, the unthreaded through-hole 110 may be elongated. Forming the unthreaded hole 110 with an increased diameter and/or elongated in at least one dimension makes alignment and adjustment of the door clamp assembly 102 easier and less time consuming during installation. Further, forming the unthreaded hole 110 requires less time during fabrication of the front rack member 78 because less precision is required for the location of an unthreaded hole 110 because it may have an increased diameter and/or because it may be elongated.

Optionally, the door clamp assembly 102 may further comprise a nut (or back) plate 109 (as best seen in FIG. 16B). The nut plate 109 is configured to be positioned between the medial mount plate 108 and the A-pillar 84. Accordingly, in some embodiments the medial mount plate 108 is positioned between the clamp member 104 and the nut plate 109.

In some embodiments, the nut plate 109 comprises a body that is rectangular and generally planar. The nut plate 109 has one or more threaded apertures. In at least one embodiment, the nut plate has three threaded apertures. The threaded apertures of the nut plate 109 correspond to (and are alignable with) the clamp through-holes 106 of the door clamp member 104 and the plate apertures 110 of the medial mount plate. In this manner, a threaded fastener 107 may extend through a clamp through-hole 106, a plate aperture 110, and threadably engage a threaded aperture of the nut plate 109.

The nut plate 109 is beneficial both when securing the front rack member 78 to the vehicle and during subsequent use of the roof rack system and the vehicle. For example, when the nut plate 109 has two or more threaded apertures, engagement of the threaded apertures by two threaded fasteners 107 prevents subsequent rotation of the nut plate 109 relative to the front rack member 78. Accordingly, it is not necessary to position a tool between the front rack support 79 to prevent movement of the nut plate as the threaded fasteners 107 are tightened as would be necessary if individual threaded nuts were used instead of the nut plate 109. Finally, when the nut plate is used with two or more threaded fasteners 107, the fasteners cannot become loose due to rotation of the nut plate as could occur if individual threaded nuts were used.

As shown in dashed lines in FIGS. 16A and solid lines in 16B, the assembly 102 may optionally include an outer (or cover) plate 111 positionable on the opposite side of the medial mount plate 108 as an exterior component of the assembly 102. Accordingly, in some embodiments, the door clamp member 104 may be positioned between the medial mount plate 108 and the cover plate 111.

The cover plate 111 may include an aperture or through-hole capable of aligning with the clamp through-hole 106 and the plate through-hole 110. A threaded fastener 107 may be passed through a through hole of the cover plate 111, through the clamp through-hole 106 and plate aperture 110, and engage threads of the threaded aperture of the nut plate as shown in FIG. 16B.

In some embodiments, the cover plate 111 is generally planar. In some embodiments, the cover plate has a width sufficient to cover the planar portion 104A of clamp from the through-hole 106 of the clamp to the beginning of the curved portion 104B of the clamp. The cover plate 111 provides additional rigidity to the door clamp assembly 102 and prevents or decreases inadvertent and unintended movement of the clamp member 104 relative to the A-pillar.

The door clamp assembly 102 optionally further comprises a rub or “wear” plate positioned between the A-pillar 84 and other components of the assembly 102 as shown in FIG. 16B. The optional wear plate 85 does not couple to the assembly 102. Instead, the wear plate 85 is provided to prevent damage or marring of the A-pillar 84 by the assembly 102.

In another non-limiting example, the front rack member 78 optionally includes a mount bracket 87 that is selectively securable to a windshield plate member 114 selectively secured to the vehicle at the top of the windshield 82 proximate to the roof 74. The windshield plate member 114 is configured to be positioned at least partially under a windshield trim component 120 of the vehicle 58 (such as a snap cover plate). Installing the windshield plate member 114 may require removing one or more of the windshield trim components 120, removing a nut from an existing fastener extending from the vehicle frame, extending the existing fastener through an aperture of the windshield plate member, coupling the windshield plate member 114 to a vehicle frame surrounding the windshield 82 proximate to the roof 74 by tightening the nut back onto the existing fastener, and re-installing the one or more of the windshield trim components 120. In this manner, the windshield plate member 114 may couple to pre-existing components proximate to the A-pillar 84 or frame surrounding the windshield 82 proximate to the roof 74. When coupled to the vehicle, a flange of the windshield plate member 114 extends above the windshield tram component. The flange includes a through-hole 118.

An extension plate 112 is selectively secured to the windshield plate member 114 and the mount bracket 87. In some embodiments the extension plate 112 is L-shaped with a first portion approximately perpendicular to a second portion. The extension plate 112 includes a through-hole 116 capable of aligning with the through-hole 118 of the windshield plate member to join the windshield plate member to the extension plate with a fastener.

Although not shown, the front rack member 78 may optionally include contact members in addition to or instead of the windshield plate member 114 and windshield trim components 116. The contact members are configured to engage the vehicle proximate to the windshield 82 and/or A-pillar 84. The contact members may comprise a soft or elastomeric material, such as a rubber or a plastic. In operation, after the front rack member 78 is interconnected to the vehicle 58, the contact members abut the vehicle 58 and prevent marring or scratching by the rack member. Optionally, the contact members may be compressible or resiliently-deflectable.

In this regard, similar to the tower assembly 2, the front rack member 78 may be interconnected to the vehicle 58 without modification of the vehicle 58 including, but not limited to, cutting, drilling, grinding, or the like.

In embodiments, a method for interconnecting a roof rack to a vehicle may include, but is not limited to, selectively securing the tower assembly 2 to the frame 60 of the vehicle 58. The method may include, but is not limited to, pivotably interconnecting the axle 68 associated with the roof rack 70 to the bracket 14 of the support tower 4 of the tower assembly 2, allowing the roof rack 70 to rotate between the first position of use and the second position of use about the common axis of rotation 88 through the bracket 14 and the axle 68 when the roof rack 70 is pivotably interconnected to the bracket 14.

The method may include, but is not limited to, selectively securing the front rack member 78 to the vehicle 58 proximate to the windshield 82 of the vehicle 58. For example, the selective securing of the front rack member 78 may include aligning the bracket through-hole 94 of the lower mounting bracket 92 of the front rack member 78 with the trim aperture 96 in the trim piece 98 of the vehicle 58 proximate to the windshield 82, and selectively securing the lower mounting bracket 92 to the trim piece via the fastener passed through the bracket through-hole 94 of the lower mounting bracket 92 and into the trim aperture 96.

In some embodiments, the selective securing of the front rack member 78 may include aligning the aperture or through-hole 116 of the upper mount plate 112 with the aperture or through-hole 118 of the windshield plate member 114. Thereafter, the upper mount plate 112 may be selectively secured to the windshield plate member 114 via the fastener passed through the aperture or through-hole 116 of the upper mount plate 112 with the aperture or through-hole 118 of the windshield plate member 114.

The method may include, but is not limited to, engaging the door clamp member 104 to the A-pillar 84 of the vehicle 58, where the door clamp member 104 has a clamp through-hole 106. The method may include, but is not limited to, selectively securing the medial mount plate 108 of the front rack member 78 to the door clamp member 104. For example, the selective securing of the medial mount plate 108 may include aligning a plate aperture 110 of the medial mount plate 108 with the clamp through-hole 106 of the door clamp member 104. By way of another example, the selective securing of the medial mount plate 108 may include passing a fastener through the clamp through-hole 106 and into engagement with the plate aperture 110.

The method may include, but is not limited to, selectively securing the roof rack 70 to the front rack member 78, where the roof rack 70 is in the first position of use when secured to the front rack member 78, and the roof rack 70 is rotatable between the first position of use and the second position of use when not secured to the front rack member 78.

It is noted the components and sub-components of the roof rack system 66 may be fabricated from a metal, carbon fiber, plastic, or other suitable material capable of supporting the empty weight of the roof rack system 66 and support a loaded weight when items are attached to or otherwise engaging (e.g., sitting on, standing on, resting on, or the like) the roof rack system 66.

At least some of the apertures or through-holes described throughout the present disclosure may be circular, which may allow for precise alignment between components and sub-components operable to engage with one another in the roof rack system 66. In addition, it is noted that at least some of the apertures or through-holes described throughout the present disclosure may be non-circular (e.g., oval, slotted, or the like), which may allow for adjustment of the various components and sub-components in the roof rack system 66 relative to one another to promote a better contouring by the components and sub-components and reduce interference, unintended, or inadvertent contact with the vehicle 58.

Although embodiments of the present disclosure describe apertures or through-holes operable to receive selective means for securing including fasteners, rivets, or the like, it is noted herein a select subset of the apertures or through-holes may instead be replaced by an affixed fastener, to which the other apertures or through-holes are selectively secured. In one non limiting example, fasteners such as a threaded rod may be affixed to the lower portion 28 of the support tower 4, and corresponding extension connector apertures or through-holes 40 may be operable to receive the affixed fasteners. The frame extension 6 may then be secured to the support 4 via a nut or the like coupled to the threaded rod after the corresponding extension connector aperture or through-holes 40 receive the affixed fasteners.

In another non-limiting example, a fastener such as a threaded rod may be affixed to the door clamp member 104. The medial mount plate 108 may then be secured to the door clamp member 104 via a nut or the like coupled to the threaded rod after the plate aperture 110 receives the affixed fastener. As such, the above description should be regarded as merely an illustration and should not be interpreted as limiting to the present disclosure.

To provide additional background, context, and to further satisfy the written description requirements of 35 U.S.C. § 112, additional information about the present disclosure is provided in Appendix A, entitled “Gobi Ford Bronco 2& 4 Door Hard & Soft Top Roof Rack Installation Instructions.” Appendix A includes additional views of roof racks and associated components of embodiments of the present disclosure and is incorporated by reference in its entirety.

Various features and embodiments of vehicle racks and devices are provided herein. It will be recognized, however, that various features are not necessarily specific to certain embodiments and may be provided on any one or more embodiments. The present disclosure and embodiments provided herein are not mutually exclusive and may be combined, substituted, and omitted. The scope of the invention(s) provided herein is thus not limited to any particular embodiment, drawing, or particular arrangement of features.

While various embodiments of the present disclosure have been described in detail, it is apparent that modifications and alterations of those embodiments will occur to those skilled in the art. However, it is to be expressly understood that such modifications and alterations are within the scope and spirit of the present disclosure. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A tower assembly for a roof rack for use with a vehicle, comprising:
a support tower, comprising:
a top plate;
a bracket affixed to the top plate, the bracket including an aperture to receive an axle for pivotably interconnecting the roof rack to the bracket;
at least one side plate extending from the top plate; and
a first tower end plate extending from the top plate to a lower portion of the at least one side plate;
a frame extension selectively coupled to the lower portion of the at least one side plate, the frame extension including an extension side plate and a first extension end plate; and
a clamp securable to the frame extension via a first fastener that engages at least one of the first extension end plate and the clamp,
wherein decreasing a distance between the frame extension and the clamp via an engagement of the first fastener selectively secures the tower assembly to a frame of the vehicle.

2. The tower assembly of claim 1, further comprising:
a first stabilizer arm selectively coupled to the support tower and the frame extension.

3. The tower assembly of claim 2, wherein the first stabilizer arm is selectively coupled to the first tower end plate and to the first extension end plate of the frame extension.

4. The tower assembly of claim 2, further comprising a second stabilizer arm selectively coupled to a second tower end plate of the support tower and a stabilizer flange of a second extension end plate of the frame extension.

5. The tower assembly of claim 4, wherein the second stabilizer arm is set at an oblique angle relative to the first stabilizer arm.

6. The tower assembly of claim 2, wherein at least a portion of the support tower including the bracket is capable of extending through a gap between adjacent exterior components of the vehicle when the tower assembly is secured to the frame, and
wherein the support tower, the frame extension, and the first stabilizer arm are adjustable relative to one another to reduce interference between the tower assembly and the frame or at least one of the adjacent exterior components of the vehicle.

7. The tower assembly of claim 1, wherein the first extension end plate comprises a clamp flange which includes a first through-hole to receive the first fastener.

8. The tower assembly of claim 7, wherein the clamp is selectively positionable adjacent to an inward portion of the frame and the first extension end plate is selectively positionable adjacent to an outward portion of the frame prior to engagement of the first fastener, wherein the clamp is drawn toward the frame and the frame extension to decrease the distance between the frame extension and the clamp during engagement of the first fastener.

9. The tower assembly of claim 1, wherein the at least one side plate of the support tower includes:
a first side plate that comprises a first upper portion that extends from the top plate of the support tower, the first side plate formed of a first piece of material with a first thickness; and
a second side plate formed of a second piece of material with a second thickness that is different than the first thickness, wherein the second side plate comprises:
a second upper portion that extends from the first side plate;
the lower portion; and
a bottom plate positioned between the lower portion and the second upper portion, the top plate being offset a select distance outward relative to the lower portion via the bottom plate.

10. The tower assembly of claim 1, further comprising:
a second extension end plate opposite to the first extension end plate; and
a frame extension stabilizer affixed to the second extension end plate, the frame extension stabilizer extending from the second extension end plate in a direction away from the extension side plate, wherein the frame extension stabilizer is configured to engage the frame such that an edge of the second extension end plate is spaced a predetermined distance from the frame when the tower assembly is secured to the frame.

11. The tower assembly of claim 1, wherein the frame extension is selectively coupled to the support tower via a second fastener that extends through the extension side plate and the lower portion of the at least one side plate.

12. The tower assembly of claim 1, wherein the first tower end plate is welded to the top plate and is formed of a third piece of material with a third thickness that is different than a first thickness of the top plate.

13. The tower assembly of claim 1, wherein the roof rack is rotatable between a first position of use and a second position of use about a common axis extending through the bracket and the axle when the roof rack is pivotably interconnected to the bracket.

14. A roof rack system for a vehicle, comprising:
a tower assembly, comprising:
a support tower including:
a top plate;
a bracket extending upwardly from the top plate; and
a side plate extending downwardly from the top plate;
a frame extension selectively coupled to the support tower, the frame extension including:
an extension side plate; and
a first extension end plate; and
a clamp selectively securable to the frame extension via a first fastener, wherein decreasing a distance between the frame extension and the clamp via an engagement of the first fastener selectively secures the tower assembly to a frame of the vehicle; and
a roof rack pivotably interconnectable to the bracket via an axle received within the bracket, wherein the roof rack is rotatable between a first position of use with the roof rack oriented approximately parallel to a roof of the vehicle, and a second position of use with the roof rack oriented at an oblique angle to the roof of the vehicle.

15. The rack system of claim 14, further comprising:
a front rack member associated with the vehicle and selectively positionable adjacent to a windshield of the vehicle, the roof rack being selectively securable to the front rack member,
wherein the roof rack is in the first position of use when secured to the front rack member, and
wherein the roof rack is rotatable between the first position of use and the second position of use when not secured to the front rack member.

16. The rack system of claim 15, wherein the front rack member includes a lower mounting bracket with a bracket through-hole that is capable of aligning with a trim aperture in a trim piece of the vehicle proximate to the windshield, and
wherein the lower mounting bracket is selectively securable to the trim piece via a second fastener passed through the bracket through-hole of the lower mounting bracket and into the trim aperture.

17. The rack system of claim 15, further comprising:
a door clamp member that is couplable to an A-pillar of the vehicle and that includes a clamp through-hole,
wherein the front rack member includes a medial mount plate with a plate aperture that is capable of aligning with the clamp through-hole of the door clamp member, and
wherein the medial mount plate is selectively securable to the door clamp member via a third fastener passed through the clamp through-hole of the door clamp member and the plate aperture of the medial mount plate.

18. A method for interconnecting a roof rack to a vehicle, comprising:
selectively securing a tower assembly to a frame of the vehicle, the tower assembly comprising a support tower with a bracket, a frame extension, and a frame extension clamp; and
pivotably interconnecting an axle associated with the roof rack to the bracket of the support tower, wherein the roof rack is rotatable between a first position of use and a second position of use about a common axis through the bracket and the axle when the roof rack is pivotably interconnected to the bracket.

19. The method of claim 18, further comprising:
selectively securing a front rack member to the vehicle proximate to a windshield of the vehicle by:
aligning a bracket through-hole of a lower mounting bracket of the front rack member with a trim aperture in a trim piece of the vehicle proximate to the windshield; and
selectively securing the lower mounting bracket to the trim piece via a first fastener passed through the bracket through-hole of the lower mounting bracket and into the trim aperture; and
selectively securing the roof rack to the front rack member,
wherein the roof rack is in the first position of use when secured to the front rack member, and
wherein the roof rack is rotatable between the first position of use and the second position of use when not secured to the front rack member.

20. The method of claim 19, further comprising:
engaging a door clamp member to an A-pillar of the vehicle, wherein the door clamp member has a clamp through-hole; and
selectively securing a medial mount plate of the front rack member to the door clamp member by:
aligning a plate aperture of the medial mount plate with the clamp through-hole of the door clamp member; and
passing a second fastener through the clamp through-hole and through the plate aperture.
